(19) United States
(12) Patent Application Publication
(10) Pub. No.: US 2010/0200107 A1
(43) Pub. Date: Aug. 12, 2010

(54) DIESEL EXHAUST FLUID STORAGE AND DISPENSING SYSTEMS

(76) Inventors: Will Weathers, Charlotte, NC (US); George Hochman, Charlotte, NC (US)

Correspondence Address: ADAMS INTELLECTUAL PROPERTY LAW, Suite 2350 Charlotte Plaza, 201 South College Street, CHARLOTTE, NC, 28244, US

(21) Appl. No.: 12/541,515

(22) Filed: Aug. 14, 2009

Related U.S. Application Data
(60) Provisional application No. 61/150,538, filed on Feb. 6, 2009.

(51) Int. Cl. B67D 5/08; B67D 5/36; B67D 5/372; B67D 5/62

(52) U.S. Cl. 141/4; 141/45; 141/82; 141/198

(57) ABSTRACT

A liquid storage and dispensing system for storing and dispensing diesel exhaust fluid to a vehicle. The system includes a diesel exhaust fluid storage tank surrounded by a housing in which the interior temperature is maintained above a first temperature at or below which salting of the fluid occurs, and below a second temperature at or above which an ammonia constituent of the fluid evaporates. The system further includes filling and dispensing systems for refilling the storage tank and dispensing the fluid.

### CROSS-REFERENCE TO RELATED APPLICATION

This application claims priority to U.S. provisional patent application No. 61/150,538, filed on Feb. 6, 2009, entitled “DIESEL EXHAUST FLUID (DEF) STORAGE AND DISPENSATION,” the contents of which are incorporated herein by reference.

### TECHNICAL FIELD AND BACKGROUND OF THE INVENTION

This application is directed generally to the storage and dispensation of fluids, and more particularly, to systems and methods for filling, storing and dispensing diesel exhaust fluid for use at fueling facilities with commercial and other diesel-powered vehicles.

Diesel-powered engines are now benefitting from a process known as Selective Catalytic Reduction (SCR), in which nitrogen oxide (NOₓ) vehicle emissions are ultimately reduced into nitrogen, water, and carbon dioxide (CO₂). In the SCR process, Diesel Exhaust Fluid (DEF), also referred to herein as “Diesel Emissions Fluid”, made up of a solution of about 32.5 percent automotive-grade urea and purified water is sprayed as a mist into the high-temperature exhaust stream, where the urea and water react under hydrolysis to produce ammonia (NH₃) and carbon dioxide (CO₂). Within an SCR element of a catalytic converter, the NOₓ gases from the engine exhaust and the ammonia from the DEF are converted into nitrogen gas (N₂) and water vapor (H₂O). While a single SCR element significantly reduces NOₓ emissions, vehicles may fitted with multiple sequential SCR elements to eliminate substantially all NOₓ gases from their exhaust. The SCR process requires an on-board DEF reservoir to supply the fluid to the exhaust stream at a rate approximately 2-4% the rate of diesel fuel consumption by volume.

It is anticipated that SCR systems will be installed by both original equipment manufacturers and as retrofit applications. Typical on-board DEF reservoir sizes are predicted to range between about several gallons to in-excess of twenty gallons, with the reservoir size being dependent upon the rate of diesel fuel consumption and vehicle range. Though these capacities are able to supply a vehicle for several thousand miles of travel, long-distance freight carrying trucks and other commercial fleet vehicles that are operated daily for long hours will require replenishment frequently enough that DEF is predicted to be made available at fueling stations along with diesel fuel.

Due to the corrosive nature of urea, DEF storage and dispensation requires the use of corrosion-resistant and non-reactive materials, such as stainless steel and polyvinylchloride (PVC), in the constructions of tanks and pipes. Thus, dedicated equipment is necessary to store and dispense DEF.

### BRIEF SUMMARY OF THE INVENTION

Accordingly, in one aspect Diesel Exhaust Fluid (DEF) storage and dispensing apparatus are provided herein for satisfying the demand for DEF at vehicle fueling centers, such as for commercial diesel-powered vehicles.

In another aspect, various embodiments of DEF storage and dispensing apparatus are provided configured for use with a variety of DEF storage tank types.

In yet another aspect, DEF storage and dispensing apparatus are provided including a temperature control unit for maintaining a predetermined temperature of stored DEF above a first temperature at or below which salting of the DEF occurs, and below a second temperature at or above which an ammonia constituent of the DEF evaporates.

In at least one embodiment of the invention, a liquid storage and distribution system for storing and dispensing DEF to a diesel-engine powered machine includes a storage tank for storing a volume of DEF, a housing defining a temperature-controllable interior environment in which the storage tank is maintained, a temperature control unit or “temperature regulator” for maintaining the temperature of the interior of the housing, a liquid dispensing apparatus for retrieving the DEF from the storage tank and supplying the liquid to an onboard storage vessel of the machine, and a vent for preventing pressure or vacuum from developing in the bulk storage tank upon filling and/or dispensing. The temperature control unit preferably maintains the interior housing environment between a first temperature at or below which salting of the DEF occurs, and a second temperature at or above which an ammonia constituent of the DEF evaporates, thus ensuring DEF fluid stability. The system may optionally include an additional system for refilling the storage tank, or may alternatively include replacing empty tanks with prefilled tote storage tanks.

In an exemplary embodiment, the housing includes thermally insulated walls.

In another exemplary embodiment, the diesel-powered machine is a vehicle.

In another exemplary embodiment, the liquid storage and distribution system includes a provider-only accessible nozzle for gaining access to refill the DEF storage tank.

In another exemplary embodiment, the temperature control unit is accessed/operated from either the interior or exterior of the housing.

In yet another exemplary embodiment, the system includes payment means for receiving customer payments and confirming authorized use.

In yet another exemplary embodiment, the liquid dispensing apparatus includes a nozzle equipped with an automatic shut-off feature to prevent overfilling and spillage.

In another embodiment of the invention, a variably mounted DEF delivery system includes a liquid dispensing apparatus for retrieving the DEF from the storage tank and delivering it to a dedicated vehicle DEF tank, and a base upon which the liquid dispensing apparatus is supported and mounted, the base being configured to either mount to a conventional tote storage tank or be supported adjacent the storage tank.

In another exemplary embodiment, the variably mounted dispensing system includes at least one adjustable mounting bar attached to the base for engaging storage tank structure.

In another exemplary embodiment, the mounting bar includes telescoping members and a locking pin for passing through aligned holes to fix the members with respect to one another.

In another exemplary embodiment, the mounting bar includes a threaded clamping bolt for engaging the storage tank or structure surrounding the storage tank.

In another exemplary embodiment, the mounting bar includes at least one hook for engaging the storage tank or structure surrounding the storage tank.

In another exemplary embodiment, the dispensing system includes a stand configured to support the base at a predetermined height above the ground, and optionally carrying a hose reel.

In another embodiment of the invention, a method of storing and delivering DEF to a diesel-engine powered machine includes storing DEF in a bulk storage tank, providing a housing in which the bulk storage tank is enclosed, maintaining the temperature of the interior of the housing above a first temperature at or below which salting of the DEF occurs, and below a second temperature at or above which an ammonia constituent of the DEF evaporates, retrieving the DEF from the storage tank, delivering the DEF to a dedicated DEF tank of the machine, and venting the bulk storage tank to prevent the build-up of pressure or vacuum.

In another embodiment, the method further includes providing a secure customer payment interface.

### BRIEF DESCRIPTION OF THE DRAWINGS

The subject matter that is regarded as the invention may be best understood by reference to the following description taken in conjunction with the accompanying drawing figures in which:

FIG. 1 is a front perspective view of an integrated DEF storage and dispensing system according to one embodiment of the present invention;

FIG. 2 is a rear perspective view of the system of FIG. 1;

FIG. 3 is a schematic diagram of a provider-accessible DEF tank fill box;

FIG. 4 is a schematic diagram of a liquid storage and pumping system;

FIG. 5 is a perspective view of a tote storage tank mounted dispensing system;

FIG. 6 is a perspective view of dispensing system mounting structure;

FIG. 7 is a perspective view of a free-standing dispensing system;

FIG. 8 is another perspective view of the dispensing system of FIG. 7;

FIG. 9 is a perspective view of free-standing dispensing system including high-mounted hose retriever;

FIG. 10 is a front perspective view of a mobile DEF storage and dispensing system;

FIG. 11 is a perspective view of the system of FIG. 10 further illustrating the storage tank;

FIG. 12 is a perspective view of another embodiment of a mobile DEF storage and dispensing system; and

FIG. 13 is a perspective view of the system of FIG. 12 illustrating the storage tank.

### DETAILED DESCRIPTION OF THE INVENTION

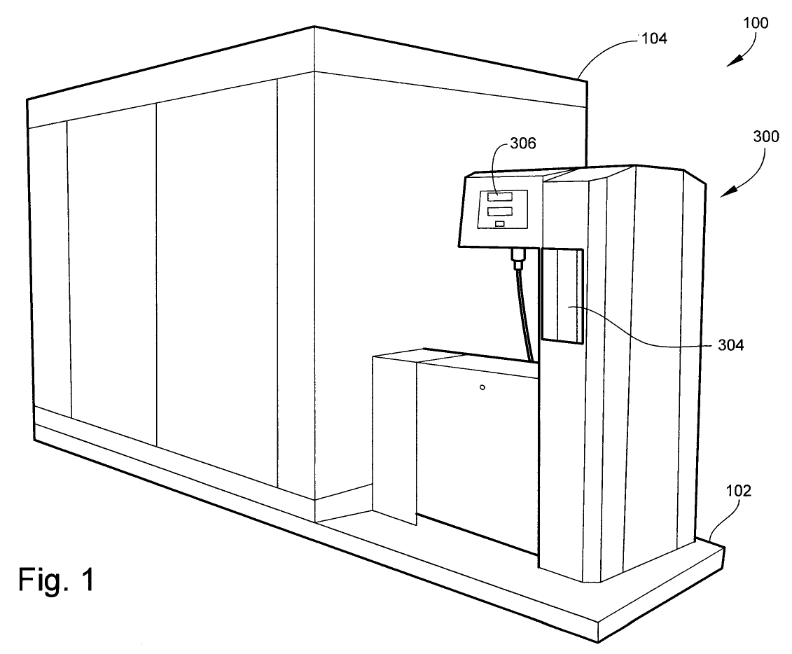

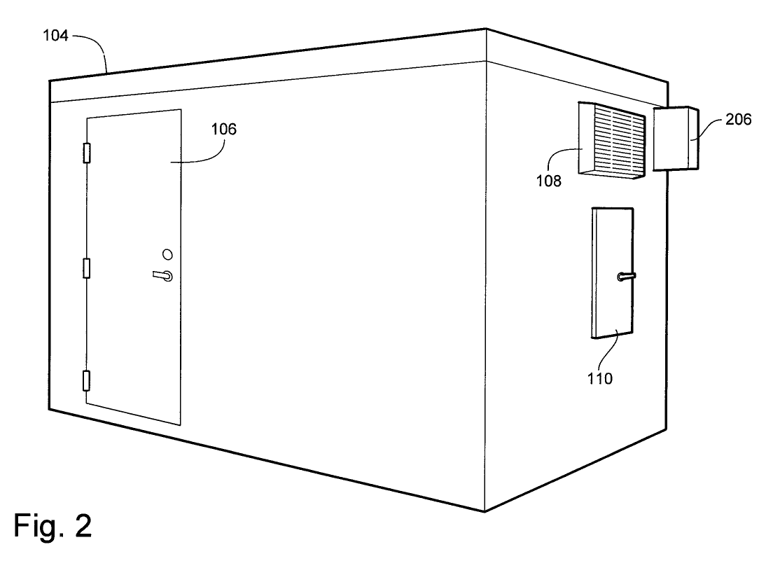

Referring now to the drawings wherein identical reference numerals denote the same elements throughout the various views, FIGS. 1 and 2 illustrate an integrated DEF storage and dispensing system 100 according to a preferred embodiment of the invention. Although the systems described herein are done so with reference to DEF, it is envisioned that the systems are suitable to store and dispense other types of fluids. The integrated system 100 includes a structural base 102 supporting a housing 104 and a liquid dispensing system 300, among other components of the system. The integrated system 100 presents a solution to DEF storage and dispensing at locations, such as diesel fueling centers, where commercial and other vehicles and machines are fueled and maintained. FIG. 2 is a rear perspective view of a portion of FIG. 1 illustrating additional housing features.

The housing 104 is an enclosure defining an interior atmosphere in which the temperature is controlled to maintain DEF stored therein within a predetermined temperature range, as described in detail below. The housing may be constructed from materials having any degree of insulating properties. In one embodiment, the housing 104 includes thermally insulated walls for aiding in maintaining the interior temperature and insulating the storage tank from the outside environment. Though any shape and relative dimension are within the scope of this description, the housing 104 is preferably sized to accommodate the size of the DEF storage tank(s) maintained therein, as well as the other components of the system including, but not limited to, pumps, hoses, gauges, controls, associated wiring, etc. A walk-in door 106 is optionally included to provide access to the housing interior. The housing 104 may be enterable by other means in order to replace pre-filled storage tanks and other components. A lock may be provided to prevent unauthorized access into the housing 104.

A temperature control unit 108 for maintaining the interior temperature of the housing 104 within a predetermined range is shown mounted within a wall of the housing 104. Controls for the unit 108 may be accessible from the interior, exterior or remotely. The temperature control unit 108 generically represents a heating device, cooling device, or a combination of both for maintaining the interior housing temperature within a predetermined range. The specific type of temperature control unit and its functions can be selected according to the installation site climate and/or the temperature requirements of the fluid being stored. In the preferred embodiment in which a urea solution such as the DEF is stored, the temperature of the solution is preferably maintained above a salt-out temperature of the solution, which varies with the concentration of the solution, and below which crystallization occurs. In one embodiment, the DEF solution includes about 32.5 percent ammonia in water. In a preferred embodiment, the temperature range is between about 12 degrees Fahrenheit (° F.) to about 100 degrees Fahrenheit (° F.), more preferably between about 20° F.-86° F., to prevent crystallization and avoid excess ammonia fumes from escaping the solution.

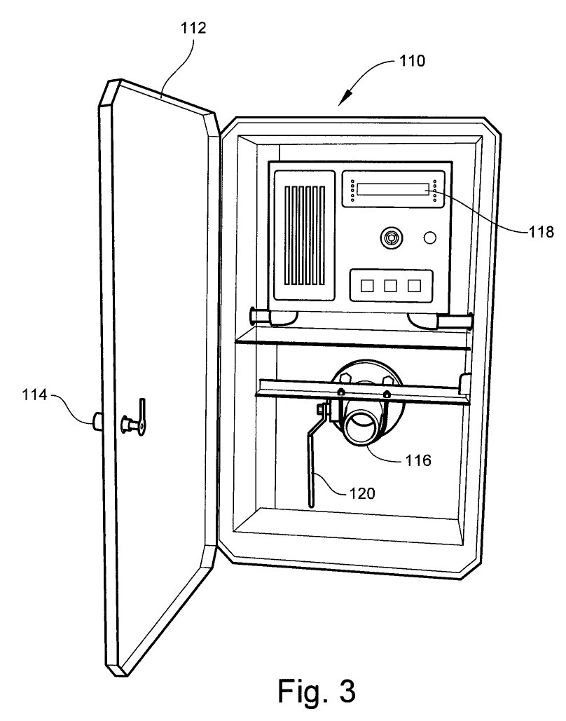

Referring to FIGS. 2 and 3, a provider-only accessible control panel 110 associated with the controls of the system 100 is provided on the housing 104. The provider control panel 110 may be positioned within a wall or collocated with the liquid dispensing system 200. The provider control panel 110 includes a security cover 112 equipped with a locking device 114 for restricting access to the panel. Access may be granted to eother the provider or DEF supplier for refilling. System controls may be located within the panel 110, such as a nozzle 116 for refilling the storage tank, a storage tank level indicator 118, flow rate controls, alarms and other controls. The controls may additionally include the temperature controls of the temperature control unit 108. In an exemplary embodiment, the liquid delivery nozzle 116 includes a corrosion-resistant stainless steel quick connect fitting having a manual valve lever 120. The storage tank level indicator 118 may include a display, such as electronic display, that informs the provider/supplier regarding the current volume level of the storage tank. The level indicator may be monitored remotely by a fluid supplier, such as via a conventional information network, to determine when a fluid delivery is required. A hatch may also be provided on the housing 104 for accessing a pump.

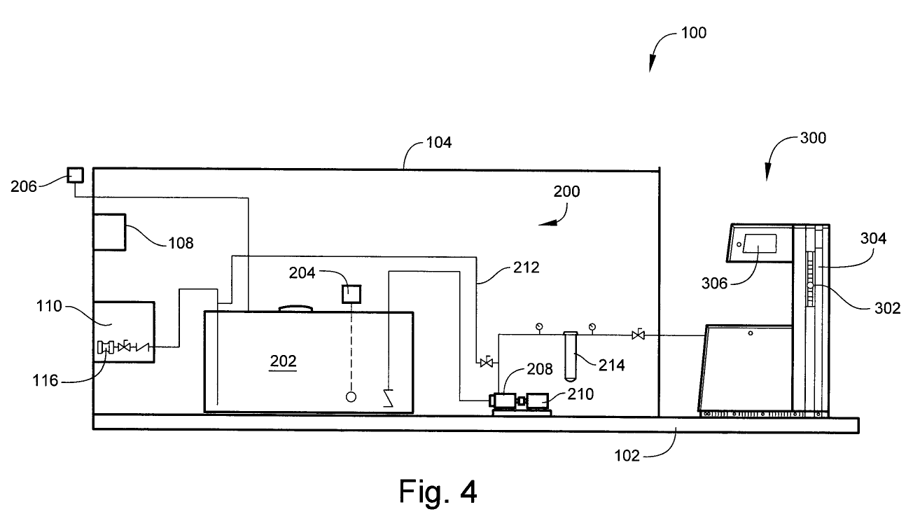

Referring to FIG. 4, a schematic diagram illustrating the DEF storage and pumping system 200 residing within the housing 104 is shown. The storage tank 202 may be configured to receive fluid through the refill delivery nozzle 116 and associated piping network of a storage tank filling apparatus, stably maintain the fluid, and dispense the fluid via an associated piping network. In an exemplary embodiment, the storage tank 202 is constructed from corrosion-resistant and inert polyethylene so as not to chemically alter the DEF. The tank defines a capacity selected based upon the demand requirements of the installation site. For example, the storage tank may have a capacity of several hundred to several thousand gallons. A tank level meter 204 monitors the current liquid volume level within the storage tank 202 and provides data to the level indicator 118. A vapor line leads from the storage tank to a vent 206 (also shown in FIG. 1) configured to release vapor over-pressure from the storage tank 202, for example during refilling of the tank, and relieves any vacuum development in the storage tank 202, for example as liquid is pumped from the tank for dispensation from the liquid dispensing system 300.

A magnetically or otherwise driven pump 208, for example a polyethylene or stainless steel centrifugal pump, turned by an electric motor 210 or other source draws liquid from the storage tank 202 for delivery to the liquid dispensing system 300. An air release line 212 releases air when the pump is activated to be Weights and Measures compliant. The line 212 may also secondarily function to return liquid from the pump 208 to the storage tank 202 to prevent overpressure in the dispensing system 300 and pump 208 when the pump is operating and the dispensing system is not dispensing pumped liquid. Thus, a re-circulating loop may be provided for metered-based delivery. The re-circulating system provides a relatively constant pressure and immediate control as flow is initiated and terminated by the user. A filter 214 may be installed at any location along the associated piping for filtering the DEF fluid. As shown, the filter 214 is situated in-line between the pump 208 and the liquid dispensing system 300, however, may alternatively be located in-line between the delivery nozzle 116 and storage tank 202 to prevent contaminants from being introduced into the storage tank 202. The dispensing system 300, downstream of the filter 214, receives liquid from the liquid storage and pumping system 200 for dispensing.

The liquid dispensing system 300 is customer accessible and includes a liquid dispensing nozzle 302 for filling a dedicated vehicle DEF tank, a nozzle dock 304 for holding the nozzle between uses, and a user interface 306 including a display. The system 300 may further include an automatic shut-off feature for preventing overfilling and spillage when the liquid level in the DEF vehicle tank reaches the dispensing stem of the nozzle 302. The user interface 306 may be configured to accept payments, input payment information, authorize use, indicate volume dispensed, provide pricing, generate receipts and connect with an information network, among other functions.

The integrated system 100 may be deployed in a variety of climates and installation environments. Components may be prewired and piped and mounted on the structural base 102, which may function to securely support the entire assembly during transport, installation, and use. Typical operations and use are essentially turnkey and thus a solution to DEF storage and dispensing is provided. The system can optionally be provided without the housing 104 in temperate climates, in installations in which another housing is already on-site, and in installations in which the temperature of the DEF fluid is maintained within the predetermined range by other means.

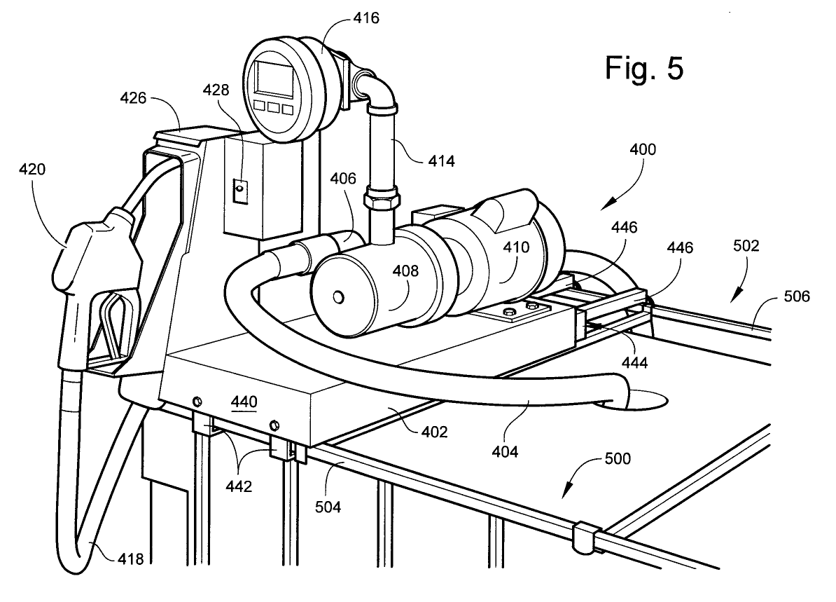

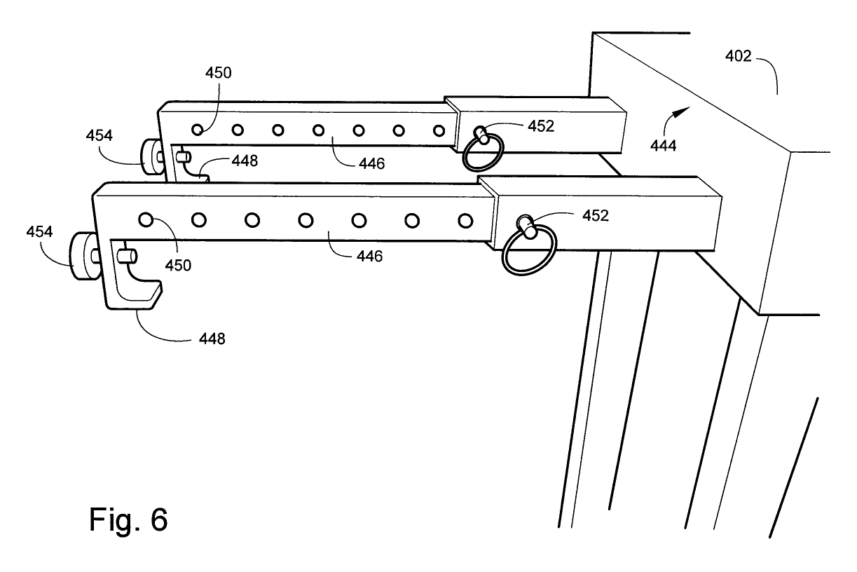

Referring to FIGS. 5-9, various embodiments of tank-mounted and free standing dispensing systems are shown. Referring specifically to FIGS. 5-6, a tank-mounted dispensing system is shown generally at 400 mounted upon a tote storage tank. The system 400 includes a supportive base 402 for mounting other components and adjustable mounting brackets thereto. An intake hose 404 extends from a DEF storage tank maintained within a cage structure 502 to an intake port 406 of a pump 408 turned by an electric motor 410. Upon activation of the electric motor 410, the pump 408 draws liquid from the DEF supply through the intake hose 404 and into a piping assembly 414 connected to the output port of the pump 408. A filter, such as in a stainless steel housing, may be included, for example, at the intake port 406, such that liquid drawn through the intake hose 404 passes through the filter before entering the pump 408. A meter 416 is placed along and is supported by the piping assembly 414. The meter 416 measures and indicates the volume of pumped liquid and may measure and indicate other flow parameters such as flow rate. An output hose 418 receives pumped liquid from the piping assembly 414 downstream of the meter 416. A liquid dispensing nozzle 420 at the end of the liquid output hose 418 includes a dispensing stem and trigger. The nozzle 420 may include an automatic shut-off feature that prevents overfilling and spillage. A nozzle dock 426 stores the nozzle 420 between uses. A switch 428 mounted upon the nozzle dock 426 may function to start/stop the electric motor 410 or start/stop the flow of fluid to the output hose 418. The system 400 may further include a user interface similar to that described above.

The system 400 is shown mounted to a storage tank 500 located within the cage structure 502. The cage structure 502 includes a plurality of top, bottom and side rails, such as exemplary rails 504 and 506. The rails may be metal rails configured to provide support to housing panels creating an enclosure around the storage tank. The cage may optionally be open and not include housing panels. A first end 440 of the base 402 is supported by rail 504 and attached thereto by downwardly extending hooks 442 of one end of adjustable length mounting bars 446. The hooks 442 are configured to partially wrap around the rails to prevent upward pulling forces from lifting the base 402 off of the cage structure 502. In one embodiment, hooks located at one end of the mounting bars may be stationary with respect to the base 402, while hooks at the other end are positionable. At a second end 444 of the base 402, mounting bars 446 extend adjustably, such as by telescoping, with respect to the base 402. Hooks 448 extend downward from the end of the slidable portion of the mounting bars 446. The mounting bars 446 are extended from the base a distance such that the hooks 448 may be partially wrapped around rail 506. Once extended to the appropriate length, the mounting bars 446 are locked in their length through locking means, such as a pin 452 received within a plurality of spaced apart holes defined along the length of the slidable portions, exemplary holes being shown at 450. Thus, the mounting bars 446 may be locked into any length to space apart the hooks 442 and 448 to engage a variety of supporting structures. A threaded clamping bolt 454 extends adjustably inward into each hook 448 to provide fine adjustment and additional engagement with a support structure engaged by the hooks 448. The holes 450 and locking pins 452 may be replaced with conventional clamping means, such as a clamp or set screw for stepless adjustment.

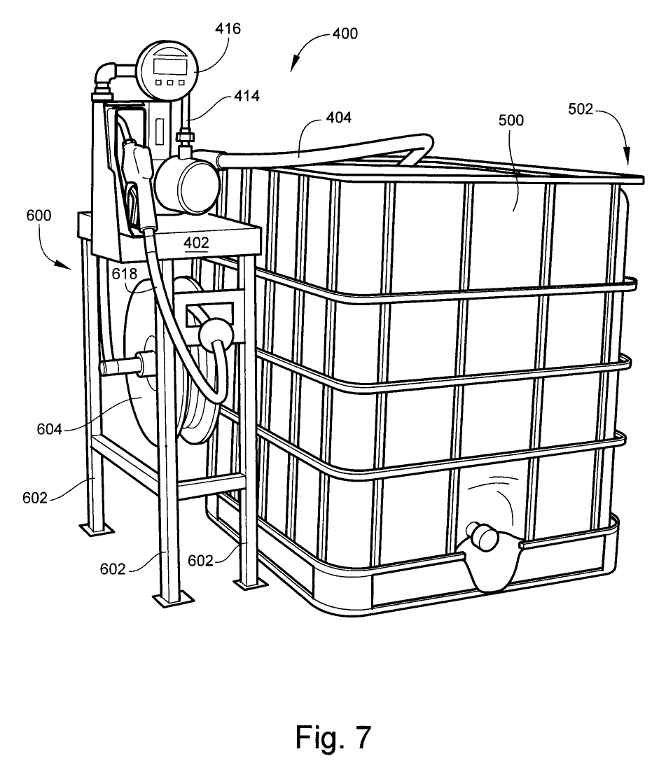

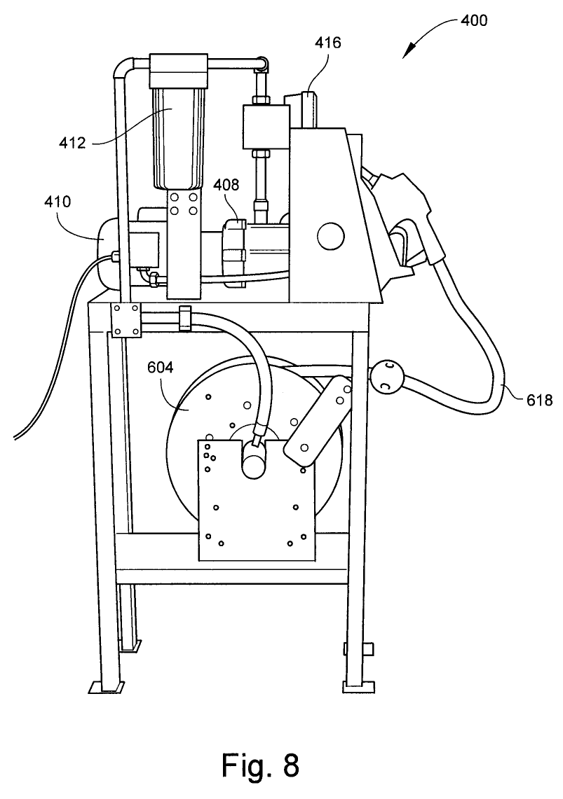

Referring to FIGS. 7-9, various free-standing dispensing systems are shown. Referring specifically to FIGS. 7-8, another variably mounted dispensing system 400 is shown including a stand 600. The stand 600 includes a plurality of braced legs 602 mounted to the base 402. A rotatably-mounted reel 604 for storing the length of the output hose 618 is supported upon an axle mounted between the plurality of legs 602 and beneath the supportive base 402. Thus, in this configuration, the reel 604 is protected from impact damage. A mechanical stop is provided along the length of the hose 618 such that the nozzle cannot be wound onto the reel or the output hose wound beyond a predetermined point. The stand 600 may be mounted to the ground or to a base that supports the DEF storage tank. The reel 604 may include a coil spring for winding the hose 618. As in the previous embodiment shown in FIG. 5, the system 400 includes a pump 408 turned by an electric motor 410 to draw liquid from a tank or reservoir. A filter 412 is located downstream of the meter 416 to assure that contaminants do not pass from the dispensing system 400 into the vehicle. A liquid output hose 618 is coiled upon the reel 604 when not in use or to store excess length.

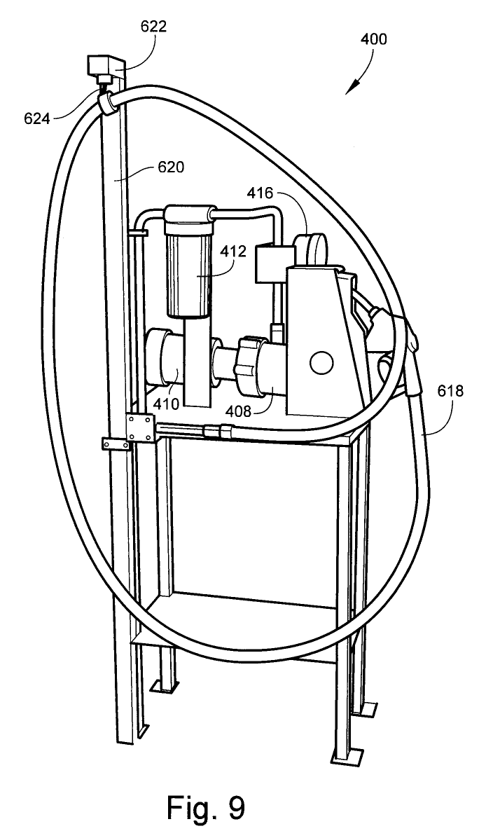

Referring to FIG. 9, the free-standing system 400 includes the same components as in FIG. 5, with the addition of a high-mounted hose return to store the hose 618 at a position elevated from the ground. As shown, the system includes a vertically upright member 620, a laterally extending member 622, and a retractable tether 624 carried by the laterally extending member 622. The tether 624 may be attached about a mid-span portion of the hose, and may be retracted by a spring force or counterweight within upright member 620.

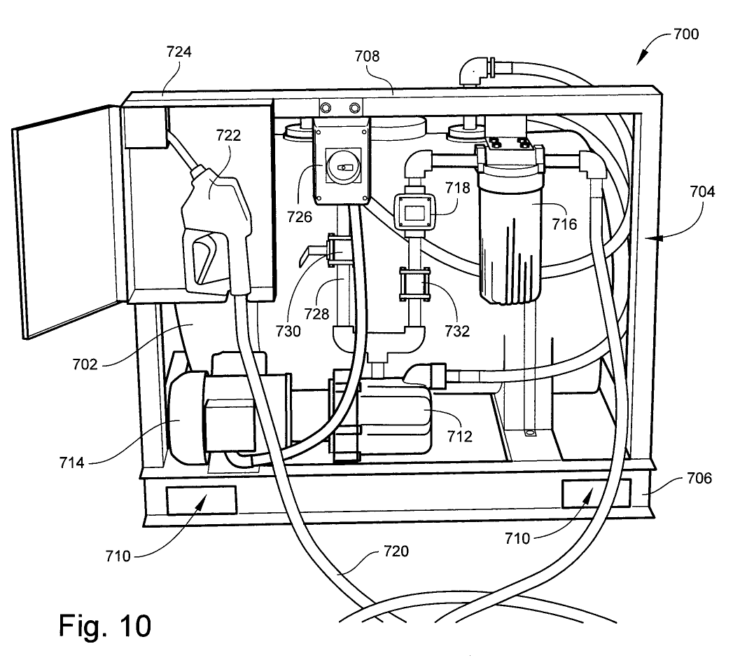

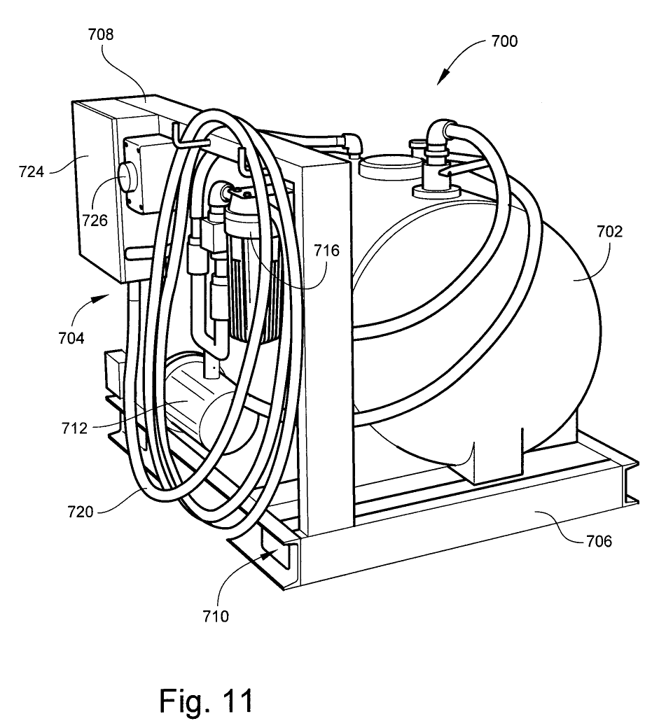

Referring to FIGS. 10 and 11, a portable liquid storage and distribution system according to another embodiment is shown generally at 700. The system 700 includes many of the components of the system shown in FIG. 5. The system 700 includes a bulk storage tank 702 for storing DEF, a liquid dispensing apparatus 704 for retrieving liquid from the storage tank 702 and pumping the liquid into the vehicle, a supportive base 706, and a structural frame 708. The base 706 defines openings 710 therethrough for receiving forklift skids to load and offload the system onto a conveyance. The liquid dispensing apparatus 704 includes a pump 712 turned by an electric motor 714 to draw liquid from the storage tank 702. A filter 716 and meter 718 is installed downstream of the pump. A hose 720 is coiled upon hooks or other structure when not in use. A dispensing nozzle 722 is returned to a storage compartment 724 when not in use. A switch 726 activates the system. A fill line 728 for the tank 702 is used to fill the tank using the pump 712, thus the pump 712 performs two functions. Valves 730 and 732 are independently opened/closed depending upon whether the pump 712 is operating to fill the tank 702 or dispense DEF through the nozzle 722. To fill the tank, valve 703 is opened and valve 732 closed. To dispense DEF, valve 730 is closed and valve 732 opened.

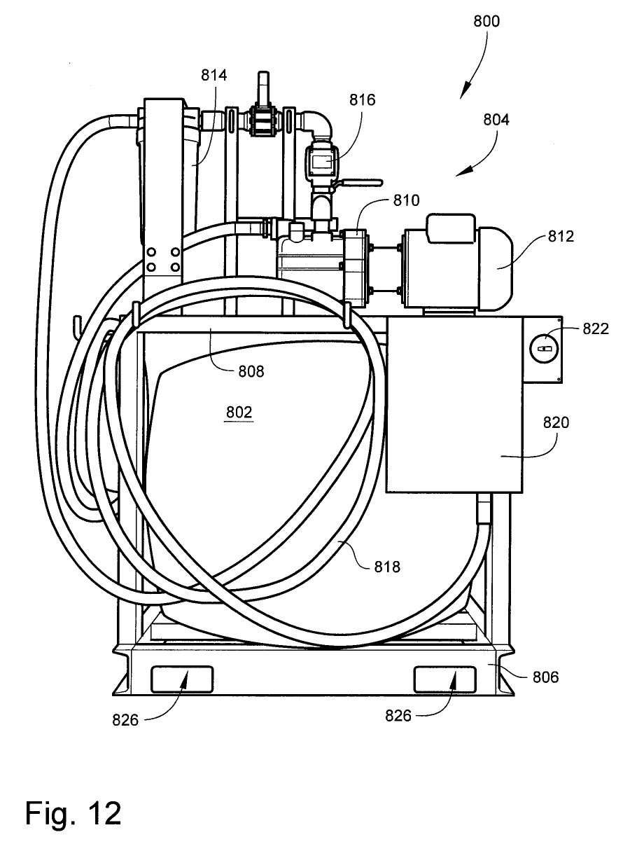

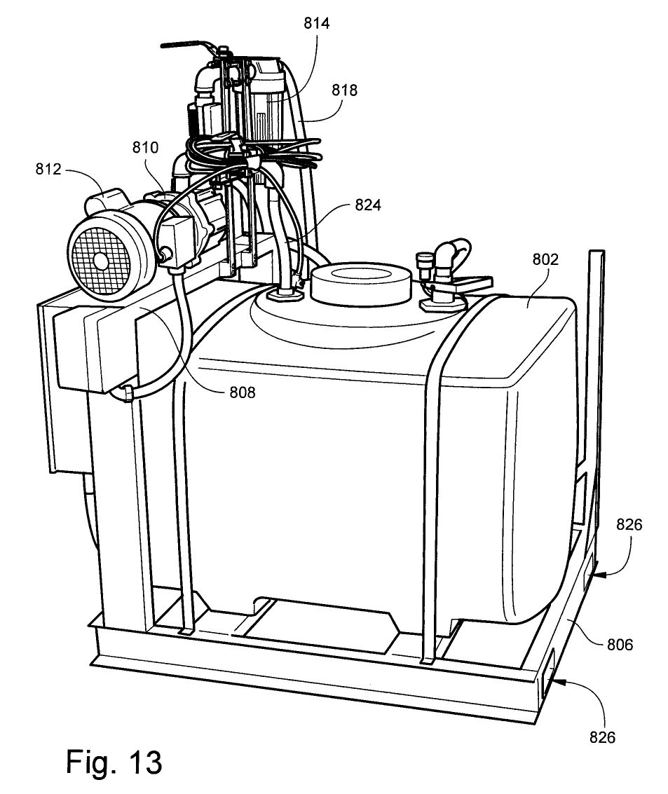

Referring to FIGS. 12 and 13, another embodiment of a mobile liquid storage and distribution system is shown generally at 800. The system 800 includes a bulk storage tank 802 for storing DEF, a dispensing apparatus 804 for retrieving DEF from the storage tank 802 and pumping the DEF into a vehicle, a structural base 806, and a frame 808. The structural base 806 is configured to support the storage tank 802 and liquid dispensing apparatus 804 for transport. The structural base 806 again defines openings 826 therethrough for receiving forklift skids. The liquid dispensing apparatus 804 includes a pump 810 turned by an electric motor 812 to draw liquid from the storage tank 802. A filter 814 and meter 816 is installed downstream of the pump 810. An output hose 818 is coiled upon hooks or other structure when not in use. The hose 818 terminates in a dispensing nozzle that is returned to a nozzle compartment 820 when not in use. A switch 822 activates the system. As in the previous embodiment, a fill line 824 for the tank 802 is used to fill the tank using the pump 810 and valve arrangement described above.

The embodiments shown in the figures optionally feature chemically resistant materials in the constructions of their components that are contacted by pumped DEF. According to such options, the pumps advantageously minimize seals that may be degraded by contact with DEF, the intake and output hoses are chemically resistant, and the dispensing nozzles and piping assemblies are constructed of stainless steel or other corrosion-resistant components.

The foregoing has described several embodiments of dispensing systems including or used in conjunction with storage systems. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation.

What is claimed is:

1. A diesel exhaust fluid storage and dispensing system, comprising:
a storage tank having a predetermined capacity for storing diesel exhaust fluid;
a housing substantially enclosing the storage tank therein;
a temperature control unit for maintaining an interior atmosphere of the housing and the stored diesel exhaust fluid within a predetermined temperature range above which salting of the diesel exhaust fluid occurs and below which ammonia constituent of the diesel exhaust fluid evaporates;
a liquid dispensing system for retrieving the diesel exhaust fluid from the storage tank comprising a pump, a motor, a delivery hose and a dispensing nozzle;
a vent for preventing pressure and vacuum from developing in the storage tank; and
an air release line for releasing air from the delivery hose to the storage tank.

2. The system according to claim 1, further comprising a storage tank filling apparatus including a nozzle and delivery line for delivering diesel exhaust fluid to the storage tank.

3. The system according to claim 2, further comprising a secure provider control panel located within a wall of the housing for providing access to the storage tank filling apparatus and a storage tank information interface.

4. The system according to claim 1, further comprising an automatic shut-off feature associated with the dispensing nozzle to prevent overfilling and spillage when a diesel exhaust fluid level in a vehicle storage tank reaches a dispensing stem of the dispensing nozzle.

5. The system according to claim 1, wherein the liquid dispensing system further includes a customer interface configured to perform at least one of the following functions: accept payments, input payment information, authorize use, indicate volume dispensed, provide pricing, generate receipts and connect with an information network.

6. The system according to claim 1, wherein the predetermined temperature range is between about 12 degrees Fahrenheit and about 86 degrees Fahrenheit.

7. The system according to claim 1, further comprising a supportive base to which the housing and liquid dispensing system are mounted.

8. The system according to claim 1, wherein the housing comprises an enclosure defining covered sides and a covered top.

9. The system according to claim 1, wherein the housing comprises a cage structure enclosing the storage tank.

10. The system according to claim 9, wherein the liquid dispensing system is supported upon a base having at least one adjustable-length mounting bar attached thereto for securely mounting the base to the cage structure enclosing the storage tank.

11. The system according to claim 10, wherein the at least one adjustable length mounting bar comprises telescoping members and means for locking the telescoping members in position relative to one another.

12. The system according to claim 1, further comprising a base supporting the liquid dispensing system, a stand supporting the base at a height above ground level, and a rotatable hose storage reel carried on the stand.

13. A diesel exhaust fluid storage and dispensing system, comprising:
a storage tank having a predetermined capacity for storing diesel exhaust fluid;
a housing substantially surrounding the storage tank;
a liquid dispensing system for retrieving the diesel exhaust fluid from the storage tank comprising a pump, a motor, a piping network and a dispensing nozzle; and
an air release line for releasing air within the piping network.

14. The system according to claim 13, further comprising a temperature control unit for maintaining the temperature of the stored diesel exhaust fluid within a predetermined temperature range above which salting of the diesel exhaust fluid occurs and below which ammonia constituent of the diesel exhaust fluid evaporates.

15. The system according to claim 14, wherein the housing is an insulated enclosure defining an interior atmosphere in which the temperature is controlled by the temperature control unit.

16. The system according to claim 13, wherein the housing comprises a cage structure.

17. The system according to claim 16, wherein the liquid dispensing system is supported upon a base having at least one adjustable-length mounting bar attached thereto for securely mounting the base to the cage structure enclosing the storage tank.

18. A method for storing and dispensing diesel exhaust fluid, comprising:
providing a storage tank and storing a volume of diesel exhaust fluid;
providing a housing and substantially enclosing the storage tank within the housing;
maintaining an interior atmosphere of the housing within a predetermined temperature range above which salting of the diesel exhaust fluid occurs and below which ammonia constituent of the diesel exhaust fluid evaporates;
retrieving diesel exhaust fluid from the bulk storage tank through a liquid dispensing system; and
providing an air release in the liquid dispensing system.

19. The method according to claim 18, further comprising the step of delivering diesel exhaust fluid to the storage tank through a delivery apparatus.

20. The method according to claim 18, further comprising utilizing a single pump to both retrieve the diesel exhaust fluid from the storage tank for dispensing and deliver the diesel exhaust fluid to the storage tank for refilling the tank.
